(19) United States
(12) Patent Application Publication
(10) Pub. No.: US 2026/0050802 A1
(43) Pub. Date: Feb. 19, 2026

(54) SYSTEM AND METHOD FOR PROTOCOL DATABASE GENERATIVE INTERFACING VIA A MULTI-CHANNEL COGNITIVE INTERACTION PLATFORM

(71) Applicant: BANK OF AMERICA CORPORATION, Charlotte, NC (US)

(72) Inventors: Tanuja Krishna Naik, Davidson, NC (US); Carlos Francisco Curiel, Matthews, NC (US); Gerard Gay, Seattle, WA (US); Lefkothea Hadjiloucas, Edison, NJ (US); Anna Mirarchi, Charlotte, NC (US); Rahul Kumar Mishra, Skillman, NJ (US); Maharaj Mukherjee, Poughkeepsie, NY (US); Elvis Nyamwange, Little Elm, TX (US)

(73) Assignee: BANK OF AMERICA CORPORATION, Charlotte, NC (US)

(21) Appl. No.: 18/802,029

(22) Filed: Aug. 13, 2024

(51) Int. Cl. G06N 5/025; G06Q 10/1093

(52) U.S. Cl. CPC G06N 5/025; G06Q 10/1093

(57) ABSTRACT

Systems, computer program products, and methods are described herein for protocol database generative interfacing via a multi-channel cognitive interaction platform. The present disclosure includes training a machine learning model, wherein the machine learning model comprises a generative machine learning model, and wherein the generative machine learning model is trained on entries of a protocol database, receiving, into a multi-channel cognitive interaction platform, an input of at least one of text, voice, and an image, detecting, using an aggregation engine, changes in the protocol database, detecting, using a relationship engine, dependencies in the protocol database comprising dependencies between the at least one protocol, and generating a generated output using the machine learning model.

### TECHNOLOGICAL FIELD

Example implementations of the present disclosure relate to a system and method for protocol database generative interfacing via a multi-channel cognitive interaction platform.

### BACKGROUND

Traditional protocol database systems restrict access to process owners and their delegates, creating significant limitations in information dissemination. These databases contain critical details about company processes, activities, vulnerabilities, controls, and metrics. However, the restricted access often results in knowledge gaps, leading to increased vulnerability and inefficiency. Users who need information find the protocol tedious and time-consuming, thus there is a need for a system and method for protocol database generative interfacing via a multi-channel cognitive interaction platform to provide for a more accessible and efficient system to manage, retrieve, and view protocol-related data.

### BRIEF SUMMARY

Systems, methods, and computer program products are provided for protocol database generative interfacing via a multi-channel cognitive interaction platform.

In one aspect, a system for protocol database generative interfacing via a multi-channel cognitive interaction platform is presented. The system may include a processing device, and a non-transitory storage device containing instructions, when executed by the processing device, the instructions cause the processing device to perform the steps of training a machine learning model, wherein the machine learning model may include a generative machine learning model, and wherein the generative machine learning model may be trained on entries of a protocol database, the entries of the protocol database may include at least one protocol, rule, and control, receiving, into a multi-channel cognitive interaction platform, an input of at least one of text, voice, and an image, wherein the multi-channel cognitive interaction platform may include the generative machine learning model, detecting, using an aggregation engine, changes in the protocol database, detecting, using a relationship engine, dependencies in the protocol database may include dependencies between the at least one protocol, and generating, in response to the input into the multi-channel cognitive interaction platform, a generated output using the machine learning model.

In some implementations, the multi-channel cognitive interaction platform may further include a rule engine, and the instructions may further cause the processing device to perform the steps of receiving, into a rule engine, the generated output may include a preliminary new rule, structuring, using the rule engine, the preliminary new rule as a new rule, and storing, in the protocol database, the new rule.

In some implementations, the instructions may further cause the processing device to perform the steps of receiving the new rule into an auto-approval engine, automatically approving the new rule via the auto-approval engine, and storing, in the protocol database, the automatically approved new rule.

In some implementations, the generated output may be selected from a group consisting of at least one of calendar data, action requests, synthesis of a new protocol, and a redline of a proposed change to an existing protocol.

In some implementations, the action requests may be transmitted to attendees in calendar meeting invitation data.

In some implementations, the relationship engine may receive outputs from the aggregation engine.

In some implementations, the relationship engine may capture applications, protocols, standards, requirements, and dependencies in the protocol database.

In another aspect, a computer program product for protocol database generative interfacing via a multi-channel cognitive interaction platform is presented. The computer program product may include a non-transitory computer-readable medium including code causing an apparatus to train a machine learning model, wherein the machine learning model may include a generative machine learning model, and wherein the generative machine learning model may be trained on entries of a protocol database, the entries of the protocol database may include at least one protocol, rule, and control, receive, into a multi-channel cognitive interaction platform, an input of at least one of text, voice, and an image, wherein the multi-channel cognitive interaction platform may include the generative machine learning model, detect, using an aggregation engine, changes in the protocol database, detect, using a relationship engine, dependencies in the protocol database may include dependencies between the at least one protocol, and generate, in response to the input into the multi-channel cognitive interaction platform, a generated output using the machine learning model.

In some implementations, the multi-channel cognitive interaction platform may further include a rule engine, and the code may further cause the apparatus to receive, into a rule engine, the generated output may include a preliminary new rule, structure, using the rule engine, the preliminary new rule as a new rule, and store, in the protocol database, the new rule.

In some implementations, the code may further cause the apparatus to receive the new rule into an auto-approval engine, automatically approve the new rule via the auto-approval engine, and store, in the protocol database, the automatically approved new rule.

In some implementations, the generated output may be selected from a group consisting of at least one of calendar data, action requests, synthesis of a new protocol, and a redline of a proposed change to an existing protocol.

In some implementations, the action requests may be transmitted to attendees in calendar meeting invitation data.

In some implementations, the relationship engine may receive outputs from the aggregation engine.

In some implementations, the relationship engine may capture applications, protocols, standards, requirements, and dependencies in the protocol database.

In yet another aspect, a method for protocol database generative interfacing via a multi-channel cognitive interaction platform is presented. The method may include training a machine learning model, wherein the machine learning model may include a generative machine learning model, and wherein the generative machine learning model may be trained on entries of a protocol database, the entries of the protocol database may include at least one protocol, rule, and control, receiving, into a multi-channel cognitive interaction platform, an input of at least one of text, voice, and an image, wherein the multi-channel cognitive interaction platform may include the generative machine learning model, detecting, using an aggregation engine, changes in the protocol database, detecting, using a relationship engine, dependencies in the protocol database may include dependencies between the at least one protocol, and generating, in response to the input into the multi-channel cognitive interaction platform, a generated output using the machine learning model.

In some implementations, the multi-channel cognitive interaction platform may further include a rule engine, and the method may further include receiving, into a rule engine, the generated output may include a preliminary new rule, structuring, using the rule engine, the preliminary new rule as a new rule, and storing, in the protocol database, the new rule.

In some implementations, the method may further include receiving the new rule into an auto-approval engine, automatically approving the new rule via the auto-approval engine, and storing, in the protocol database, the automatically approved new rule.

In some implementations, the generated output may be selected from a group consisting of at least one of calendar data, action requests, synthesis of a new protocol, and a redline of a proposed change to an existing protocol.

In some implementations, the action requests may be transmitted to attendees in calendar meeting invitation data.

In some implementations, the relationship engine may capture applications, protocols, standards, requirements, and dependencies in the protocol database.

In some implementations, the relationship engine may receive outputs from the aggregation engine.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for protocol database generative interfacing via a multi-channel cognitive interaction platform, in accordance with an implementation of the disclosure;

FIG. 2 illustrates an exemplary machine learning model subsystem architecture, in accordance with an implementation of the disclosure; and

FIGS. 3A-3B illustrate a process flow for protocol database generative interfacing via a multi-channel cognitive interaction platform, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model to perform functions as a foundation for the larger piece of software that drives the functionality of the software. The machine learning model for any given engine may be self-contained (e.g., without interaction with other engines), or the machine learning model may be shared across one or more engines. In other words, some implementations of the larger piece of software many implement multiple machine learning models to perform functions of the various engines. In other implementations, a single machine learning model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

As used herein, a “protocol database” may refer to a centralized repository for processes, policies, and standards (e.g., governmental standards) of an entity, including procedures, guidelines, and other documents. As used herein, a “protocol” may refer to an entity process. The protocol database may include a user-facing protocol database application displayable on an interface (e.g., a user interface or display of an endpoint device), such that when a user clicks on a protocol or standard, there may be requirements listed, or they could be otherwise associated through metadata. Protocols may have process identifiers, corresponding lines of exchange, relevant stakeholders, and compliance metrics. Additionally, the database can include version histories, approval workflows, and audit trails to ensure traceability of changes. Users can search and filter policies based on various criteria, such as department, policy type, and effective dates. The protocol database may also facilitate updates, as will be described herein, to reflect current practices and regulatory requirements.

As an example of the purpose of one implementation of the protocol database in practice, the use of the protocol database could involve a user accessing the protocol database (via the protocol database application, for example) to prepare for a “Server Maintenance” activity. The user would review the associated vulnerabilities, such as “Hardware Failure,” and ensure that all controls, like “Regular Hardware Inspections,” are in place. The user would also check metrics to ensure that the “Backup Success Rate” meets a predefined 99% threshold. If any documentation needs updating, the user would follow the procedures outlined in the protocol database to maintain compliance and operational efficiency.

The technical problem solved herein relates to the restricted access to protocol databases, which are limited to process owners and their delegates. This restriction leads to significant knowledge gaps, as essential information regarding company protocols, activities, vulnerabilities, controls, and metrics is not readily accessible to all users. These knowledge gaps can cause delays in decision-making and execution, as users spend considerable time and computing resources locating necessary information. Additionally, the lack of comprehensive access impedes cross-functional collaboration, as users cannot easily share or verify critical data. This restricted access also increases the likelihood of outdated or incomplete information being used, potentially leading to errors or oversight in protocol management.

Current solutions to this technical problem include implementing role-based access controls and creating protocol documentation repositories accessible to a broader range of users. Role-based access controls assign varying levels of access to different users based on their roles within the organization. However, these solutions are often inadequate as they still rely on predefined roles and permissions, which may not dynamically adapt to changing organizational needs or the diverse requirements of users. Protocol documentation repositories, while providing broader access, can become quickly outdated, leading to discrepancies between documented protocols and actual practices. Additionally, these repositories may lack integration with other critical systems, which may result in fragmented information that requires further manual consolidation. Consequently, these current solutions do not fully address the inherent inefficiencies and vulnerabilities associated with limited access to comprehensive and up-to-date protocol information.

Addressing these challenges requires the establishment of a system and method for protocol database generative interfacing via a multi-channel cognitive interaction platform. Such a system provides for an interactive digital assistant that can provide schematic diagrams of various protocols in the protocol database, activities, vulnerabilities, and controls there, as well as other resources to minimize the computational resources and time required for activities involving the updating of entries in the policy database or analysis thereof.

To do so, the system may use a multi-channel cognitive interaction platform that includes a machine learning model, which may be a generative machine learning model (for example, a large language model), that has been trained using entries of a protocol database (e.g., protocols, rules, controls, and so forth). The multi-channel cognitive interaction platform may receive text, voice, image(s), or the like, from a user or plurality of users. An aggregation engine may detect changes in the protocol database, and a relationship engine may detect and map dependencies in the protocol database between the protocols therein. Using such information from the aggregation engine and the relationship engine, as well as the input provided to the multi-channel cognitive interaction platform (in conjunction with the machine learning model and the training data used to train such machine learning model) the system may then generate a generated output. The generated output may be calendar data, action requests, action requests that may be transmitted to attendees in calendar meeting invitation data, synthesis of a new protocol, and/or a redline of a proposed change to an existing protocol. This generated output, in some implementations, may be received by a rule engine if the generated output is a preliminary new rule. This preliminary new rule may be structured (i.e., transformed) using the rule engine to result in a new rule that is stored in the protocol database. This new rule, under certain criteria (as will be described in detail herein) may be automatically approved (e.g., by a machine learning model) and integrated into the protocol database.

What is more, the present disclosure provides a technical solution to a technical problem. As described herein, the technical problem includes restricted access to protocol databases, which are often limited to process owners and their delegates. The present disclosure embraces an improvement over existing solutions by allowing for the analysis of pre-existing protocols and implementation of new protocols (i) with fewer steps to achieve the solution (e.g., generating proposed changes to existing protocols based on inputs into the system), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., generating with relative ease a proposed changes to existing protocols that are in line with expectations and integrate without conflict with the protocols in the protocol database), (iii) removing manual input and waste from the implementation of the solution, thus improving speed and efficiency of the process and conserving network resources (e.g., taking voice and text data to generate action items, follow-up meetings, proposed changes to protocols, etc. none of which would require manual input), (iv) determining an optimal amount of resources that need to be used to implement the solution, thus reducing network traffic and load on existing network resources (e.g., minimizing redundant efforts in protocol database analysis). In other words, the solution may bypass a series of steps previously implemented, thus further conserving network resources. Furthermore, the technical solution described herein uses a rigorous, computerized process to perform specific tasks and/or activities that were not previously performed.

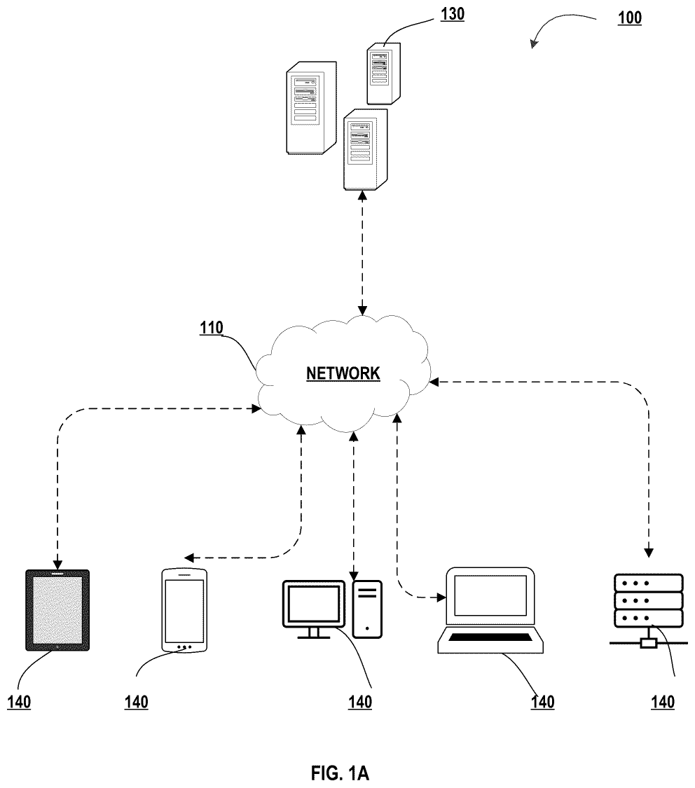

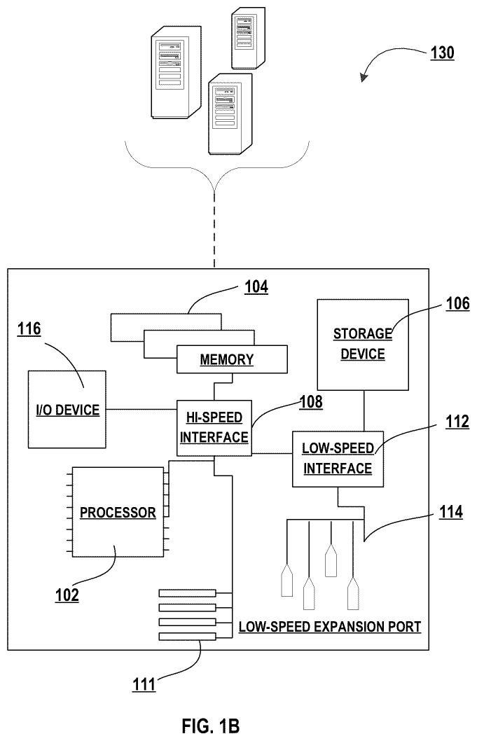

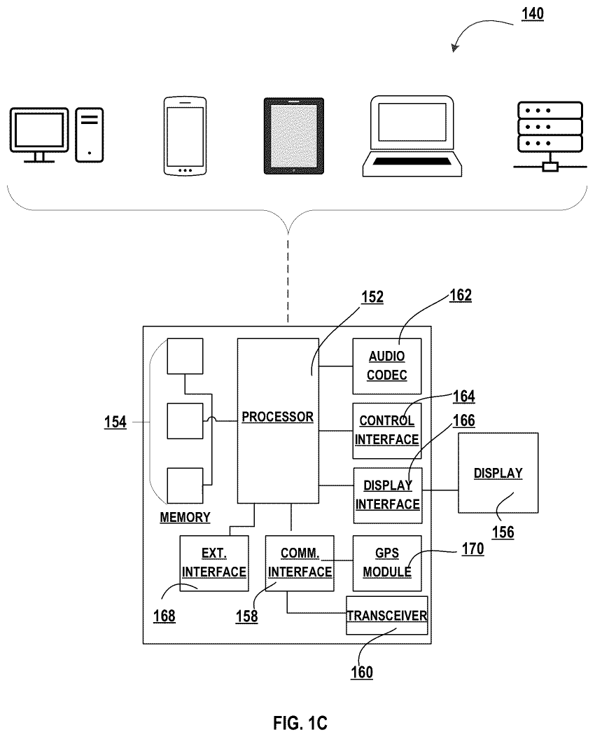

FIGS. 1A-1C illustrate technical components of an exemplary distributed computing environment 100 for protocol database generative interfacing via a multi-channel cognitive interaction platform, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive service from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer- or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive r device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer- or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

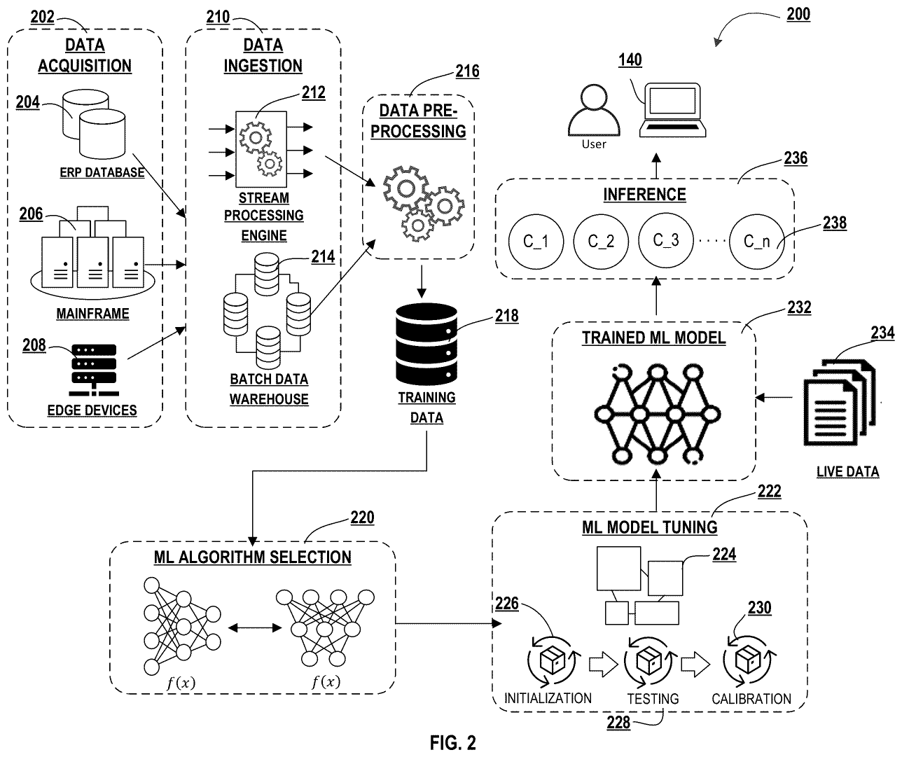

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

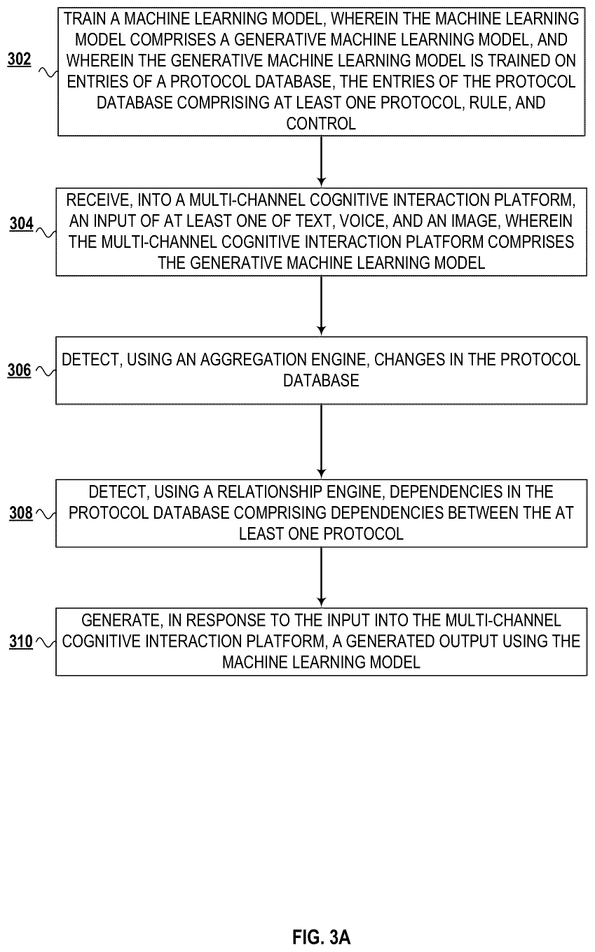

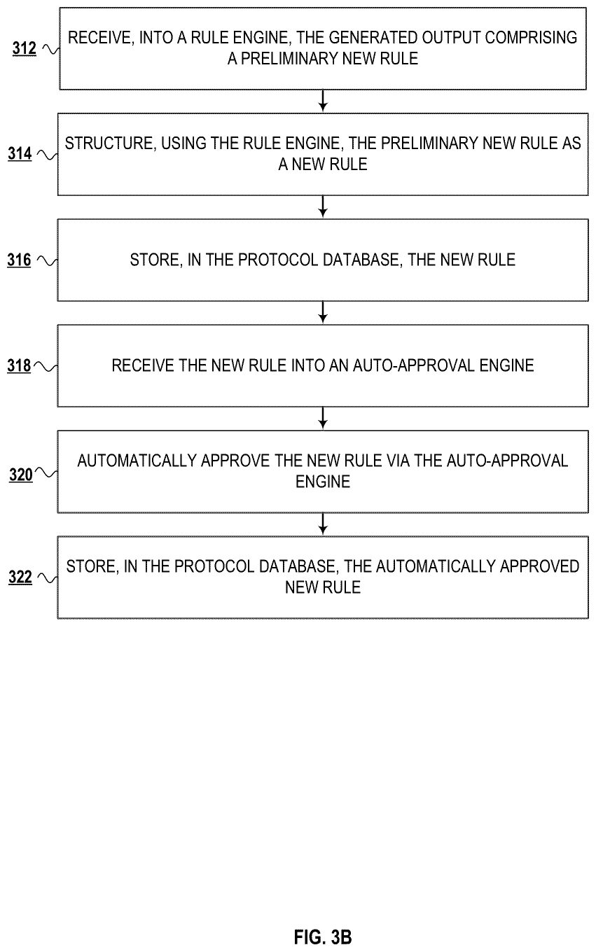

FIGS. 3A-3C illustrate a process flow for protocol database generative interfacing via a multi-channel cognitive interaction platform, in accordance with an implementation of the disclosure. At block 302, the system 130 may train a machine learning model. In some implementations, the machine learning model 232 is trained without supervision (i.e., unsupervised learning), while in other implementations, the machine learning model 232 may be trained with supervision (i.e., supervised learning).

The machine learning model 232 may include a generative machine learning model, such as a large language model using transformer-based techniques for natural language processing and understanding, Generative Adversarial Networks (GANs), Variational Autoencoders (VAEs), Autoregressive Models, Flow-based Models, Energy-Based Models, or the like.

As previously described, an entity system 130 may contain a protocol database that contains policies and standards of an entity, including procedures, guidelines, and other documents. Standards may have listed requirements therewith, version histories, approval workflows, audit trails, and so forth. Accordingly, the complex interconnectivity between these policies, standards, procedures, guidelines, and documents may be captured through training of the machine learning model, such that subsequent queries of the model may reveal such interconnectivities in a manner easy to understand and digest, such as through a mind map with a central topic and corresponding branches therefrom, flowcharts, or other diagrams displayed on an interface of an endpoint device 140.

The generative machine learning model may be trained on entries of the protocol database, for example a protocol, rule, control, and so forth, and combinations thereof. This may be done in several steps. First, data collection and preprocessing may be performed, which includes extracting workflow and procedure data from the protocol database, cleaning it to remove inconsistencies, and transforming it into a structured format such as JSON or CSV. For example, workflows might be represented as sequences of steps, while procedures are detailed descriptions of actions within those steps. Each workflow and procedure may be labeled and organized.

Feature engineering may be used to identify key attributes of the workflows and procedures. For example, features might include the number of steps in a workflow of the protocol database, the duration of each step, dependencies between steps, and the specific actions required in each procedure. The data may then be split into training, validation, and test sets. A selected model is trained on the training data, adjusting its parameters to learn the patterns and relationships between different workflows and procedures.

Hyperparameter tuning may be implemented to optimize the model performance. Parameters such as the learning rate, the number of hidden layers, and the size of the input sequences may be fine-tuned. The machine learning model 232 may be evaluated on the test set to assess its accuracy. For example, the model might be tested on its ability to predict the next step in a workflow or identify the most efficient procedure for a given protocol. Finally, the model is deployed to ingest new workflow and procedure data from the protocol database, while continuously learning and adapting as new data becomes available.

Next, at block 304, the system 130 may receive, into a multi-channel cognitive interaction platform, an input of at least one of text, voice, and an image. As used herein, a “multi-channel cognitive interaction platform” may refer to an engine, model, or system configured to receive, recognize and interpret linguistics of user input and perform user activities accordingly. In general, the multi-channel cognitive interaction platform may parse the user input from the user to detect one or more words that make up the activity input from the user. The multi-channel cognitive interaction platform may then analyze words to determine the user activity. Based on receiving the activity input from the user, in some instances, the multi-channel cognitive interaction platform is configured to generate a parse tree based on detected one or more words and/or the detected keywords. The multi-channel cognitive interaction platform may analyze the parse tree to determine the user activity to be performed and the intent of the user and also to determine any parameters provided by the user for an invoked service. The multi-channel cognitive interaction platform may invoke another application, a service, an activity functionality and the like based on its analysis of a parse tree. The multi-channel cognitive interaction platform may be configured to hold complex and branched conversations with the user, in the pursuit of completing one or more user activities. In this regard, the multi-channel cognitive interaction platform is configured to detect and conduct branched conversations using intelligent complex path looping. In some instances, the multi-channel cognitive interaction platform may identify a suitable conversation path for completion of a user-initiated activity and proceed to request information accordingly.

In some implementations, the multi-channel cognitive interaction platform may include the generative machine learning model, such as to provide a generative output from the one or more words or keywords provided to the multi-channel cognitive interaction platform by a user. Such generative output may include text (e.g., in the form of paragraphs, sentences, etc.), images (e.g., in the form of images of trees that illustrate relationships between protocols, inputs, outputs, etc.), documents (e.g., in the form of draft word processor documents, spreadsheets, pdfs, etc.), or the like.

Continuing at block 306, the system 130, using an aggregation engine, may detect changes in the protocol database. In some implementations, the system 130 may include an aggregation engine. The aggregation engine may summarize dependencies that are captured by a relationship engine (e.g., an engine that capture applications, protocols, standards, and requirements, from the protocol database and thereafter map the dependencies between such applications, protocols, standards, and requirements) and feeds these dependencies back to the machine learning model 232 for improvement over time. In this way, dependencies within protocols may be captured and recorded if previously unknown. The aggregation engine may collect and consolidate data from multiple sources such as the protocol database, relationship engine, rule engine, or the like, into a single, unified view. The aggregation engine may process and normalize the data to provide consistency and may also filter, sort, or enrich the data before presenting it to the user or system 130.

In some implementations, the aggregation engine queries the protocol database for changes. Additionally, or alternatively, the aggregation engine may implement Change Data Capture methods to determine the changing of data in the protocol database. Additionally, or alternatively, the aggregation engine may analyze transaction logs in the protocol database to determine changes. Additionally, or alternatively, the protocol database may implement webhooks to notify the aggregation engine of any changes.

Continuing at block 308, the system 130, using a relationship engine, may detect dependencies in the protocol database. These dependencies may include dependencies between the at least one protocol, application, standard, requirements, or any combination thereof. For example, one protocol may be dependent on another protocol. Each of these protocols, individually, may have standards or protocols to which they are beholden. Accordingly, the relationship engine may gather the dependency information between the two protocols, while also capturing the corresponding standards and protocols for each protocol. In some examples, there may be redundancies as a result of tying protocols together using the relationship engine, such that a standard or protocol is referenced more than one time (e.g., by more than one protocol individually, as one example). Accordingly, the relationship engine may remove such redundancies/duplicative relational information, and instead may make each of the affected protocols dependent on a single instance of the standard, protocol, etc.

The outputs of the aggregation engine and/or the relationship engine may be fed on a consistent basis (for example, at a predetermined interval, or in real-time) to the machine learning model 232. In this way, the machine learning model 232, when queried through the multi-channel cognitive interaction platform, may take into consideration the most up-to date data and thereby improve the usefulness of any output generated by the machine learning model 232 (via generative AI/ML).

At block 310, the system 130 may generate, in response to the input into the multi-channel cognitive interaction platform, a generated output using the machine learning model 232. In some implementations, the generated output may be a text output, such as in a natural language. For example, an input to the multi-channel cognitive interaction platform may include a query in a natural language, asking about any interdependencies between protocols, regulations, or the like, such as to assess at a high level the intricacy and challenges that may result from changes to any such protocols or regulations. In other words, the system 130 may provide an impact assessment. Similarly, in some implementations, the input to the multi-channel cognitive interaction platform may include voice data received from an in-person or online meeting (e.g., via microphone input). In conjunction with a prompt (via voice data or text data) presented to the multi-channel cognitive interaction platform alongside the voice data, the output may be a text or voice output that contains an answer to the provided prompt, such as a summary of the meeting, an impact assessment, an overview of the interdependencies between protocols, regulations, or the like, and so forth.

In some implementations, the generated output may include calendar data. For example, in response to an input that includes text data, voice data, or the like, that contains suggestions for a follow-up meeting, the multi-channel cognitive interaction platform may generate calendar data (e.g., an electronic meeting invitation) for a predetermined amount of time from the present date. If the input contains any mention of participants in a meeting or other individuals, the calendar data may include such person(s) as recipients.

In some implementations, the generated output may include action requests. As used herein, an “action request” may be an electronic communication describing an action that needs to be taken as it pertains to a protocols, regulations, or any other protocol in the protocol database. The electronic communication may be an email, instant message, system alert, notification, push notification, or the like. The action request may be directed at one or more particular individuals based on the input to the multi-channel cognitive interaction platform, or the action request may be a generic action request, such as action data to be provided to project management software for tracking purposes. In some implementations, the action requests may be transmitted to attendees via calendar meeting invitation data.

In some implementations, the generated output may include synthesis of a new protocol. For example, the generated output may be a protocol definition such as a descriptive name, followed by an explanation of the protocol, scope, and objectives. For example, if you are adding a “Vendor Management” protocol, the protocol definition might outline the steps for selecting, onboarding, and managing vendors to meet organizational standards and regulatory requirements.

Additionally, or alternatively, the new protocol produced as the generated output may include activities required to complete the protocol, description, responsible parties, expected outcomes or the like. Continuing with the previous example, activities for Vendor Management might include “Vendor Selection,” “Vendor Onboarding,” and “Performance Monitoring.” Additionally, or alternatively, the new protocol produced as the generated output may include descriptions of the vulnerabilities, including possible causes and impacts. Continuing with the previous example, descriptions of these vulnerabilities for Vendor Management could include “Vendor Non-Compliance” and “Data Security Breach.” Additionally, or alternatively, the new protocol produced as the generated output may include control measures and provide explanations of how each control works and its effectiveness. Continuing with the previous example, control measures for Vendor Management might include “Regular Audits” and “Data Encryption.” Additionally, or alternatively, the new protocol produced as the generated output may include performance metrics to measure the success of each activity and/or acceptable ranges or limits for each metric. Continuing with the previously example, for Vendor Management, performance metrics might include “Vendor Performance Score” and “Incident Response Time.”

Additionally, or alternatively, the new protocol produced as the generated output may include documentation (e.g., procedural guides, standards, and any other relevant information). Continuing with the previous example, for Vendor Management, documentation might include a “Vendor Selection Criteria” guide detailing criteria for evaluating potential vendors and an “Onboarding Checklist” form to ensure all onboarding steps are completed.

Additionally, or alternatively, the new protocol produced as the generated output may include dependencies and relationships, including by identifying interdependencies with other protocols and conducting an impact analysis to understand how changes in this protocol might affect other areas. Continuing with the previous example, for Vendor Management, dependencies and relationships may be coordination with the Legal Department for contract review, and changes in vendor performance could affect project timelines. Additionally, or alternatively, the new protocol produced as the generated output may include training materials. For Vendor Management, training materials may include vendor management training modules for the Procurement Team, scheduled training sessions and documentation handovers.

In some implementations, the generated output may include a redline of a proposed change to an existing protocol. While the forgoing sections refer to a protocol that is new as a generated output, it shall be appreciated that it may be beneficial to present potentially new protocols, or revisions to existing protocols, as redline document(s) for review and subsequent approval. Accordingly, potential changes to protocols may be generated and presented as redline document(s) including, but not limited to, the description of the protocol, the activities required to complete the protocol, description, responsible parties, expected outcomes, descriptions of vulnerabilities, control measures, performance metrics, procedural guides, dependencies, training materials, or the like.

It shall be appreciated that any of the generated outputs discussed herein may be displayed on a user interface of a user device such as to provide a user of the endpoint device 140 with a graphical view of the generated output. In some implementations, the graphical view may include a 3D flowchart/network diagram or mind map that illustrates any interconnectivity between the generated output and other protocols, rules, etc. of the protocol database. In this way, a user may visualize the scope of an impact of any changes to the protocol database prior to implementing changes.

Turning now to block 312 of FIG. 3B, in some implementations, the system 130 may receive, into a rule engine of the multi-channel cognitive interaction platform, the generated output. This generated output, for example, may include a preliminary new rule (e.g., a portion of the protocol related to a specific guideline or principle that governs behavior or actions within the protocol). One example of a new rule may be that any purchase order exceeding $10,000 must be approved by the CFO. This rule may apply within the broader procurement protocol to foster oversight.

Next, at block 314, the system 130 may structure, using the rule engine, the preliminary new rule as a new rule. The new rule stems from the preliminary new rule, obtained from the generated output of the multi-channel cognitive interaction platform, that may become a new rule once transformed by a rule engine. Accordingly, the “rule engine” may be an engine configured to transform outputs from the multi-channel cognitive interaction platform as new rule(s). If not already in such a format, the rule engine may define the rule (from the preliminary new rule) in a standard format like decision table, rule flow, or scripted rules. Additionally, or alternatively, the rule engine may add metadata like rule name, description, priority, and effective dates to the preliminary new rule. Additionally, or alternatively, the rule engine may specify conditions under which the rule (per the preliminary new rule) is applicable and actions to be taken when those conditions are met. Additionally, or alternatively, the rule engine may organize the preliminary new rule into categories or groups for easier management and retrieval. Additionally, or alternatively, the rule engine may validate the syntax and logic of the preliminary new rule (e.g., by performing testing to ensure correctness). Additionally, or alternatively, the rule engine may maintain version history of the rule (after the preliminary new rule becomes a new rule) for tracking changes and rollback capabilities. At block 316, the system 130 may store the new rule in the protocol database.

In some implementations, the process may continue at block 318, where the system 130 may receive the new rule into an auto-approval engine. It shall be appreciated that larger entities often have numerous protocols and rules that are similar to one another. As such, review and approval of these rules and protocols, after being generated as preliminary new rules or new rules, is often a time-consuming task that requires users to individual audit new or preliminary new rules prior to implementing into the protocol database.

Accordingly, the present system 130 may include an auto-approval engine to approve new rules or preliminary new rules without having to wait for input from a user. The system 130 may auto-approve new rules or preliminary new rules similar to those which has been previously approved, while it may leave more unique new rules or preliminary new rules for manual approval. To do so, a machine learning model 232 (either a second machine learning model 232, or in some implementations, the same machine learning model 232 implemented in the multi-channel cognitive interaction platform) may be programmed by gathering and preprocessing a labeled dataset of rules, splitting it into training and test sets, and identifying relevant features. A classification model such as a Random Forest may be trained, and similarity measure like cosine similarity may be implemented. A predefined threshold for auto-approval may be determined based on this similarity. The predefined threshold for auto-approval may be adjusted as needed to optimize the model. The machine learning model 232 may be deployed, with its performance being continuously monitored. New data, (e.g., new rules) may be used to retrain the machine learning model 232 on an ongoing basis.

Next, at block 320, the system 130 may automatically approve the new rule via the auto-approval engine. For a new rule or a preliminary new rule, the machine learning model 232 may calculate the similarity of the new rule or a preliminary new rule to approved rules and auto-approve if it exceeds the threshold. Otherwise, the new rule or preliminary new rule may be flagged for user approval.

Once the new rule or preliminary new rule has been approved (either auto-approved via the machine learning engine, or approved by a user), the process may continue at block 322, where the new rule or preliminary new rule is stored in the protocol database. In this way, the protocol database is continuously updated by receiving approved rules, which provides changes that can be detected by the aggregation engine (see block 306), changes detected by the relationship engine (see block 308), and generated output via the generative machine learning model that may include portions of the updated protocol database, and so forth. This continuous process creates a closed-loop system for managing the protocol database and activities associated therewith, such that many of the processes occur autonomously.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for protocol database generative interfacing via a multi-channel cognitive interaction platform, the system comprising:
a processing device; and
a non-transitory storage device containing instructions, when executed by the processing device, the instructions cause the processing device to perform the steps of:
training a machine learning model, wherein the machine learning model comprises a generative machine learning model, and wherein the generative machine learning model is trained on entries of a protocol database, the entries of the protocol database comprising at least one protocol, rule, and control;
receiving, into a multi-channel cognitive interaction platform, an input of at least one of text, voice, and an image, wherein the multi-channel cognitive interaction platform comprises the generative machine learning model;
detecting, using an aggregation engine, changes in the protocol database;
detecting, using a relationship engine, dependencies in the protocol database comprising dependencies between the at least one protocol; and
generating, in response to the input into the multi-channel cognitive interaction platform, a generated output using the machine learning model.

2. The system of claim 1, wherein the multi-channel cognitive interaction platform further comprises a rule engine, and wherein the instructions further cause the processing device to perform the steps of:
receiving, into a rule engine, the generated output comprising a preliminary new rule;
structuring, using the rule engine, the preliminary new rule as a new rule; and
storing, in the protocol database, the new rule.

3. The system of claim 2, wherein the instructions further cause the processing device to perform the steps of:
receiving the new rule into an auto-approval engine;
automatically approving the new rule via the auto-approval engine; and
storing, in the protocol database, the automatically approved new rule.

4. The system of claim 1, wherein the generated output is selected from a group consisting of at least one of calendar data, action requests, synthesis of a new protocol, and a redline of a proposed change to an existing protocol.

5. The system of claim 4, wherein the action requests are transmitted to attendees in calendar meeting invitation data.

6. The system of claim 1, wherein the relationship engine receives outputs from the aggregation engine.

7. The system of claim 1, wherein the relationship engine captures applications, protocols, standards, requirements, and dependencies in the protocol database.

8. A computer program product for protocol database generative interfacing via a multi-channel cognitive interaction platform, the computer program product comprising a non-transitory computer-readable medium comprising code causing an apparatus to:
train a machine learning model, wherein the machine learning model comprises a generative machine learning model, and wherein the generative machine learning model is trained on entries of a protocol database, the entries of the protocol database comprising at least one protocol, rule, and control;
receive, into a multi-channel cognitive interaction platform, an input of at least one of text, voice, and an image, wherein the multi-channel cognitive interaction platform comprises the generative machine learning model;
detect, using an aggregation engine, changes in the protocol database;
detect, using a relationship engine, dependencies in the protocol database comprising dependencies between the at least one protocol; and
generate, in response to the input into the multi-channel cognitive interaction platform, a generated output using the machine learning model.

9. The computer program product of claim 8, wherein the multi-channel cognitive interaction platform further comprises a rule engine, and wherein the code further causes the apparatus to:
receive, into a rule engine, the generated output comprising a preliminary new rule;
structure, using the rule engine, the preliminary new rule as a new rule; and
store, in the protocol database, the new rule.

10. The computer program product of claim 9, wherein the code further causes the apparatus to:
receive the new rule into an auto-approval engine;
automatically approve the new rule via the auto-approval engine; and
store, in the protocol database, the automatically approved new rule.

11. The computer program product of claim 8, wherein the generated output is selected from a group consisting of at least one of calendar data, action requests, synthesis of a new protocol, and a redline of a proposed change to an existing protocol.

12. The computer program product of claim 11, wherein the action requests are transmitted to attendees in calendar meeting invitation data.

13. The computer program product of claim 8, wherein the relationship engine receives outputs from the aggregation engine.

14. The computer program product of claim 8, wherein the relationship engine captures applications, protocols, standards, requirements, and dependencies in the protocol database.

15. A method for protocol database generative interfacing via a multi-channel cognitive interaction platform, the method comprising:
training a machine learning model, wherein the machine learning model comprises a generative machine learning model, and wherein the generative machine learning model is trained on entries of a protocol database, the entries of the protocol database comprising at least one protocol, rule, and control;
receiving, into a multi-channel cognitive interaction platform, an input of at least one of text, voice, and an image, wherein the multi-channel cognitive interaction platform comprises the generative machine learning model;
detecting, using an aggregation engine, changes in the protocol database;
detecting, using a relationship engine, dependencies in the protocol database comprising dependencies between the at least one protocol; and
generating, in response to the input into the multi-channel cognitive interaction platform, a generated output using the machine learning model.

16. The method of claim 15, wherein the multi-channel cognitive interaction platform further comprises a rule engine, and wherein the method further comprises:
receiving, into a rule engine, the generated output comprising a preliminary new rule;
structuring, using the rule engine, the preliminary new rule as a new rule; and
storing, in the protocol database, the new rule.

17. The method of claim 16, wherein the method further comprises:
receiving the new rule into an auto-approval engine;
automatically approving the new rule via the auto-approval engine; and
storing, in the protocol database, the automatically approved new rule.

18. The method of claim 15, wherein the generated output is selected from a group consisting of at least one of calendar data, action requests, synthesis of a new protocol, and a redline of a proposed change to an existing protocol.

19. The method of claim 18, wherein the action requests are transmitted to attendees in calendar meeting invitation data.

20. The method of claim 15, wherein the relationship engine captures applications, protocols, standards, requirements, and dependencies in the protocol database.
